(19) United States
(12) Patent Application Publication
(10) Pub. No.: US 2026/0241731 A1
(43) Pub. Date: Aug. 20, 2026

(54) SELF-INKING STAMP WITH REINFORCED CROSSBAR

(71) Applicant: COLOP STEMPELERZEUGUNG SKOPEK GESELLSCHAFT M.B.H. & CO. KG., Wels (AT)

(72) Inventors: Johann WILFLINGSEDER, Dorf an der Pram (AT); Bernhard SKRICKA, Wels (AT)

(73) Assignee: COLOP STEMPELERZEUGUNG SKOPEK GESELLSCHAFT M.B.H. & CO. KG., Wels (AT)

(21) Appl. No.: 19/154,847

(22) PCT Filed: Feb. 12, 2024
(86) PCT No.: PCT/AT2024/060044

§ 371 Date: Aug. 8, 2025

(30) Foreign Application Priority Data
Feb. 10, 2023 (AT) A 50086/2023

(51) Int. Cl. B41K 1/36

(52) U.S. Cl. CPC B41K 1/36

(57) ABSTRACT

A self-inking stamp includes a lower part in which a stamp unit coupled to an actuating part that is displaceable relative to the lower part is mounted, the lower part including two side parts which are connected to one another at a bottom end of the lower part by at least one crossbar including a metallic reinforcing element, wherein the reinforcing element is formed separately from the side parts, is accommodated in a receptacle of the crossbar, and is connected to the side parts via the receptacle.

The invention relates to a self-inking stamp with a lower part in which a stamp unit coupled to an actuating part that is displaceable relative to the lower part is mounted, wherein the lower part has two side parts which are connected to one another at a bottom end of the lower part by at least one crossbar comprising a metallic reinforcing element. In particular, the invention relates to a self-inking stamp having at least partially metallic side parts. These are typically particularly durable and reliable stamps for frequent use over a long period of time.

The invention also relates to a method for reinforcing a crossbar of such a self-inking stamp.

Self-inking stamps generally comprise a self-contained, circumferential frame at their bottom end, which in a state of use faces a substrate to be printed. The frame is substantially formed by the bottom ends of two side parts and crossbars running between them. The crossbars are designed with small dimensions transversely to their longitudinal extension in order to allow both unhindered passage of a stamp plate or a type unit through an opening surrounded by the frame, and to allow a user of the stamp to access the stamp plate or the type unit. Consequently, if the thin crossbars are made of plastic, they may be permanently bent or broken during handling of the stamp, especially in case of careless or improper use. To avoid this, it is known to form the crossbars from metal, but this makes the manufacturing of the stamp more complex, as the crossbars have to be welded to the side parts. Alternatively, the crossbars are formed from plastic and reinforced with a metallic reinforcing element, the reinforcing element being manufactured in one piece with the side parts. The side parts and the crossbars are cut out of a piece of sheet metal. Due to the required openings for the passage of and access to the stamp plate or type unit, manufacturing from a piece of sheet metal involves a sheet metal waste that increases the manufacturing costs of the stamp.

EP 3 307 546 B1 discloses a stamp with a frame and with a positioning frame, which serves to reduce the size of an interior of the frame. A reinforcing bar is provided in the interior of the frame to improve stability.

U.S. Pat. No. 1,275,893 A discloses a self-inking hand stamp with side plates made of sheet metal, which are connected to one another on the bottom side by bolts.

WO 2016/197172 A1 shows a self-inking stamp with a combination of plastic and metal parts, the metal parts being arranged so as to be visible on the outside.

WO 87/04980 A1 and US 2010/263560 A1 each show a self-inking stamp with a lower part formed from metal, which comprises mutually opposite side walls and connecting rods connecting these side walls to one another at their lower end.

The object of the invention is now to provide a self-inking stamp and a method for reinforcing a crossbar of a self-inking stamp of the type mentioned above, which avoid or at least reduce the disadvantages mentioned. In particular, the crossbar of the self-inking stamp should be resistant to bending and breaking and at the same time be simple and inexpensive to manufacturable.

For this purpose, the invention provides a self-inking stamp as in claim 1 and a method as defined in claim 13. Advantageous embodiments and developments are specified in the dependent claims.

According to the invention, the object is achieved by a self-inking stamp, wherein the reinforcing element is formed separately from the side parts, is received in a receptacle of the crossbar, and is connected to the side parts via the receptacle. The self-inking stamp thus comprises a lower part in which a stamp unit is mounted. The stamp unit comprises at least one stamp print relief, i.e. a stamp plate or a type unit, which bears the contours or symbols (letters, numbers, characters) to be depicted during stamping. The self-inking stamp also comprises an actuating part, for example a handle, which is displaceable relative to the lower part and coupled to the stamp unit. By pressing down the actuating part in the direction of a substrate to be printed, the stamp unit is lowered, rotated about a turning axis and the stamp print relief is brought into contact with the substrate to be printed. The lower part comprises two side parts, each of which can have a guide for the turning axis.

To increase the stability of the stamp, the side parts are connected to one another at a bottom end of the lower part by at least one crossbar comprising a metallic reinforcing element. The crossbar, for example, reliably determines the distance between the side parts. The crossbar is preferably arranged perpendicular to a main plane of extension of the side parts.

If the reinforcing element were formed integrally with the side parts, a piece of sheet metal containing the side parts and the reinforcing element would have to be cut to size accordingly and the reinforcing element would have to be bent about a horizontal or vertical axis. In addition to the associated workload, the sheet metal waste also represents a cost loss. If, on the other hand, the reinforcing element is manufactured separately and welded to the side parts, the welding device required for this increases the cost.

According to the invention, it is therefore provided that the reinforcing element is formed separately from the side parts, is received in a receptacle of the crossbar, and is connected to the side parts via the receptacle. The reinforcing element is thus manufactured separately from the side parts and can be purchased at low cost. Due to the separate design of the reinforcing element, the latter can comprise a greater thickness than the side parts (i.e. a larger diameter in a sectional plane normal to the side parts and to the bottom side). As a result, a higher rigidity can be achieved than in solutions in which the side parts and a reinforcing element are formed, for example, from a sheet metal blank and consequently comprise the same thickness.

In order to connect to the side parts, the reinforcing element is inserted into a receptacle on the crossbar and connected to the side parts via the receptacle. The stability, in particular the flexural strength, of the crossbar is thus increased compared to a crossbar without a metallic reinforcing element. The connection between the reinforcing element and the side parts via the receptacle preferably does not require additional metallic connecting elements (screws or rivets) and can be manufactured without additional metalworking steps (such as welding or riveting or tumbling). The receptacle does not have to define all degrees of freedom of the reinforcing element. It is substantially sufficient to support the reinforcing element normally on the bottom side of the stamp and to avoid a displacement between the stamp plate and a substrate and an associated disturbance of the stamp function. On the other hand, the reinforcing element can be displaceably mounted in its longitudinal direction, i.e. along and within the crossbar, as long as it is arranged at least partially in the crossbar and thus contributes to its rigidity or resistance (“reinforcing” the latter). Rotation of a possibly round reinforcing element about its longitudinal axis may also be free and need not be fixed by the receptacle.

It should be noted that the bottom end of the lower part does not necessarily have to run in one plane, i.e. may have sections with different heights above a substrate to be printed. For example, in a state in which the stamp is placed on a substrate to be printed, the crossbar, which forms part of the bottom end of the lower part, may be at a somewhat greater distance from the substrate than the lower ends of the side parts. The crossbar can have small cross-sectional dimensions, so that above the crossbar, access to a stamp plate carrier mounted inside the lower part and/or a type unit is possible. However, the crossbar may also be part of a closed side wall of the lower part.

If reference is made in this description to indications of location and direction, these indications are to be understood in a position of use, i.e. in a stamping position of the stamp in which the stamp is placed on a substrate to be printed. Specifically, the term “up” refers to a position near an actuating part of the stamp and “down” refers to a position near a ground contact surface of the stamp. The term “vertical” means in the direction of gravity.

According to a preferred embodiment of the invention, the side parts are connected to one another at a bottom end of the lower part by two crossbars, each comprising a metallic reinforcing element, as a result of which an opening is formed between the side parts and the crossbars for the passage of a stamp print relief of the stamp unit, the reinforcing elements are formed separately from the side parts, are accommodated in receptacles of the crossbars, and are connected to the side parts via the receptacles. By providing two crossbars, which are preferably arranged perpendicular to the main plane of extension of the side parts, the stability of the stamp can be further increased. In addition, the stamp, which comprises two crossbars, can be placed particularly reliably on a substrate. The crossbars also facilitate the alignment of the stamp when it is placed on the substrate, e. g. relative to an edge of a document or to a font line or a table frame. The crossbars are sufficiently spaced apart from one another to form an opening between the side parts and the crossbars for a stamp print relief of the stamp unit to pass through.

If the receptacle is formed of plastic, the receptacle can be manufactured inexpensively with an expedient cross-sectional profile (in particular for connection to the side parts) and with low weight. The receptacle can thus be formed, for example, by a plastic mounting or two plastic mounting (one for each side part), which is connected, for example, to the side parts (in each case) and in which the reinforcing element is held. Both connections, i.e. firstly between the side part and the plastic mounting and secondly between the plastic mounting and the reinforcing element, can be form-fitting connections. At least one of these can be a snap connection, which is manufacturable in a particularly simple and cost-effective manner due to the flexibility of the plastic.

In order to be able to accommodate the reinforcing element in the receptacle as easily as possible, it is advantageous if the receptacle comprises an outer shell made of at least two interconnected crossbar parts made of plastic. The reinforcing element can thus be accommodated between the crossbar parts, wherein the crossbar parts are in a separate state or at least not completely connected to one another during the accommodation of the reinforcing element. The outer shell can be formed over the entire surface or with through-openings. The two interconnected crossbar parts can be configured, for example, to form a pipe section in the connected state, which extends in the longitudinal direction along a partial section, in particular along at most one third, at most one fifth or at most one tenth of the distance of the side parts from one another between the two side parts. The reinforcing element can be accommodated and held in the pipe sections, which can also be partially circumferentially open. The mounting can be achieved, for example, by positive engagement (e.g. snapping the reinforcing element into the receptacle or receptacles) or non-positive engagement (e.g. clamping) or by an adhesive connection.

In order to further simplify the positioning of the reinforcing element, the receptacle may have two outer shells made of at least two interconnected crossbar parts made of plastic, the outer shells being mounted on different side parts. For example, the outer shells may be designed as pipe sections which extend in the longitudinal direction, for example along a partial section, in particular along at most one third, at most one fifth or at most one tenth of the distance between the side parts between the two side parts.

Preferably, each crossbar part comprises an outer surface and an inner surface opposite the outer surface and recessed in the direction of the outer surface, the recessed inner surfaces forming the receptacle as a receiving channel when the crossbar parts are connected to one another. The receptacle can thus be designed as a receiving channel, wherein the recessed, i.e. curved, inner surfaces of the interconnected crossbar parts form the channel passage of the receiving channel. The receiving channel preferably extends along the entire distance of the side parts from one another between the two side parts.

Furthermore, it can be provided that the crossbar parts of each crossbar are an upper crossbar part and a lower crossbar part, and the lower crossbar parts additionally extend under the side parts and jointly form a closed frame. The frame running under the upper crossbar parts and under the side parts may have a flat base surface and/or stamp bases protruding downwards therefrom for placement on a substrate to be printed. In particular, the side parts can be placed on the frame. For this purpose, the frame can comprise, for example, tongue-shaped insertable elements which protrude upward, i.e. in the direction of the actuating part, engage with the side parts and position the frame with respect to the side parts. In addition, the frame can comprise latching elements that engage with complementary latching elements in the side parts and reliably hold the frame on the side parts.

In order to reliably support the reinforcing element, it is preferred that both side parts comprise a recess that continues each receptacle, in particular each receiving channel, in which the reinforcing element is received, in particular mounted. The recess may, for example, have the same cross-section profile as the receptacle, in particular the receiving channel. In particular, a center axis of the receptacle, for example of the pipe section or of the receiving channel, can coincide with the center axis of the recess.

With regard to a particularly simple construction, it can be provided that the reinforcing element is a rod, in particular with a round, particularly preferably circular cross-section (i.e. a round rod). The (preferably cylindrical) rod may have a length that is less than, equal to, or greater than the distance between the two side parts. For example, the rod can have a length of 100% to 120% (in the case of a passage through the side parts or below the side parts) or at most 80% or at most 60% or at most 40% or at most 20% of the distance between the side parts. The diameter of the rod can be between 1 mm and 4 mm, in particular between 2 mm and 3 mm.

If the rod is made of stainless steel, the rod can also be used in a humid environment without the risk of rust formation. Thus, a step of galvanization for the manufacturing of a stainless rod can be dispensed with.

In terms of simple manufacturing and in order to avoid tilting during the receiving of the reinforcing element, it is preferred that the receptacle, in particular the receiving channel, and preferably the recess is round in cross-section, preferably circular. In particular, the recess can be designed as a pipe part cut in the longitudinal direction and can therefore have a part of a circle in cross-section.

In order to avoid the ingress of dirt between the receptacle and the reinforcing element, it is advantageous if the reinforcing element is substantially completely covered by the crossbar parts. It should be noted that the substantially complete cover allows for minor openings, such as narrow slots, that remain, for example, after connecting the crossbar parts to each other. The substantially complete cover can also give a visually appealing impression of the self-inking stamp.

According to a further embodiment, it can be provided that the crossbar parts forming the receptacle, in particular the receiving channel, are detachably connected to one another, in particular are connected to one another by a latching connection. The detachable connection allows the reinforcing element to be removed again if necessary after the interconnected crossbar parts have been detached. The latching connection enables, in particular, a tool-free, quick and reliable connection of the crossbar parts to one another. For the latching connection, for example, one of the crossbar parts can have a spring-mounted hook element, which engages in a complementary hook receptacle on the other crossbar part.

The object stated above is also achieved by a method for reinforcing a crossbar of a self-inking stamp formed according to the preceding description, wherein, according to the invention, the side parts are provided with at least a part of a receptacle and the reinforcing element is then mounted in the receptacle. The receptacle, or at least a part of it, can already be fixed, in particular permanently attached, to the side parts before the reinforcing element is mounted in the receptacle, or can be provided separately from the side parts. In particular, the separately formed reinforcing element can be inserted into the receptacle. With regard to the features of the method, reference is also made to the preceding description of the self-inking stamp, insofar as this is helpful for understanding the method and insofar as features of the method can be derived from this description of the self-inking stamp. Likewise, with regard to the features of the self-inking stamp, reference is also made to the description of the method.

According to a preferred embodiment of the method, the reinforcing element can be inserted into a crossbar part of the crossbar and the crossbar part with the reinforcing element inserted therein can be connected to the other crossbar part of the crossbar. The separately provided reinforcing element can thus be quickly inserted between the crossbar parts of the crossbar and without bolted fastening, adhesive bondings or welded joints. In other exemplary embodiments, the reinforcing element inserted between the crossbar parts can also be adhesively bonded to the crossbar parts. After the reinforcing element has been inserted, the crossbar parts are connected to one another and the receptacle is thus closed.

The invention is explained in more detail below on the basis of preferred, non-limiting exemplary embodiments with reference to the drawings. The drawings show:

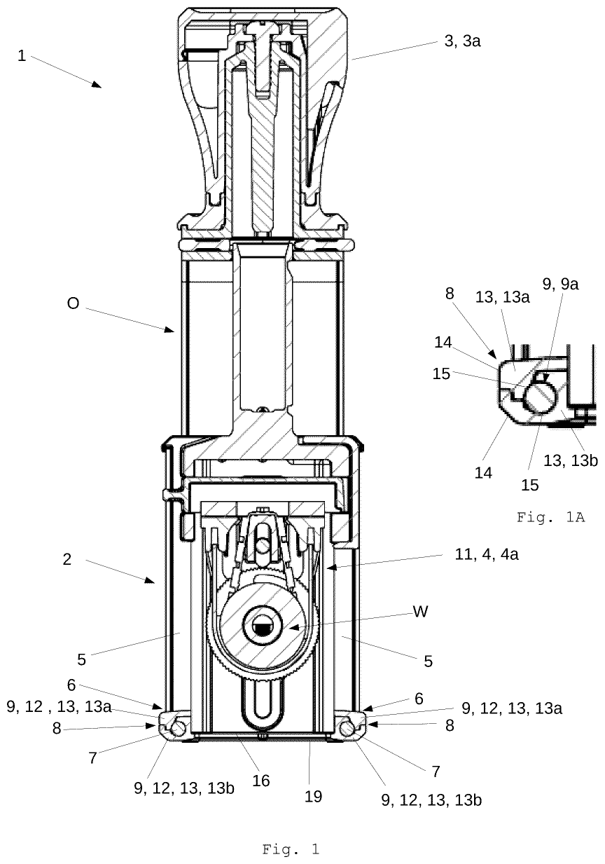

FIG. 1 shows a self-inking stamp according to the invention in a sectional side view;

FIG. 1A is an enlarged sectional view of a crossbar of the self-inking stamp of FIG. 1;

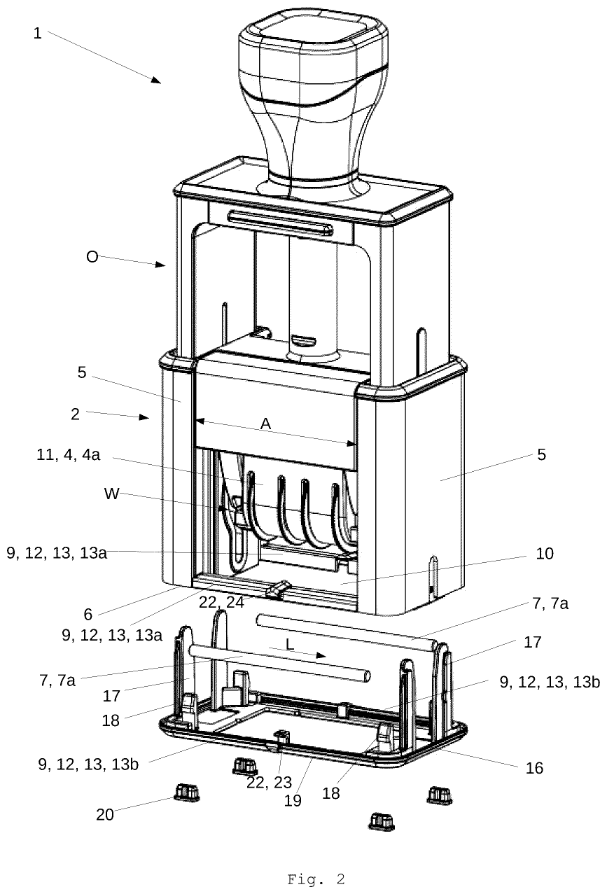

FIG. 2 shows the self-inking stamp of FIG. 1 in a diagrammatic, partially exploded view, which represents a separate closed frame and separate reinforcing elements;

FIG. 3 shows a lower part of the self-inking stamp of FIG. 1 in a diagrammatic view from below;

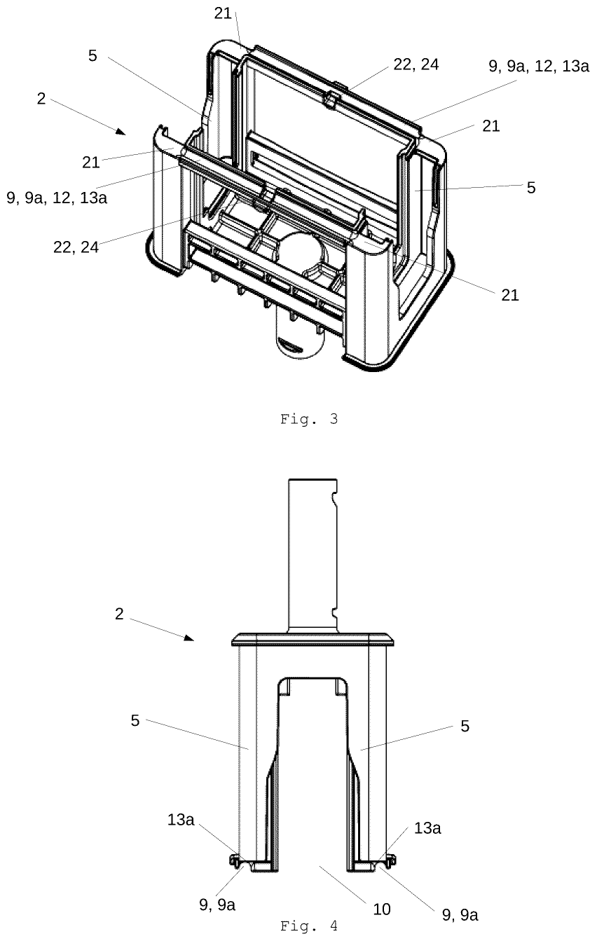

FIG. 4 is a side view of the lower part of FIG. 3;

FIG. 5 shows the frame of FIG. 2 with metallic reinforcing elements inserted therein, in a diagrammatic view obliquely from above;

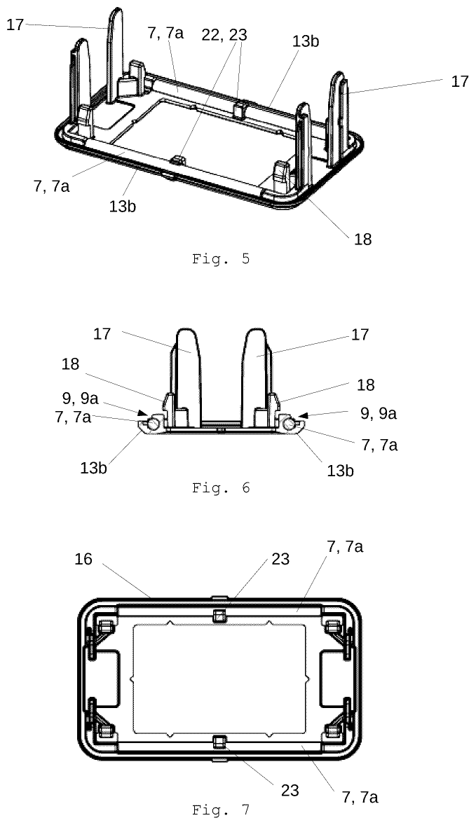

FIG. 6 shows the frame of FIG. 2 with metallic reinforcing elements inserted therein, in a side view; and

FIG. 7 shows the frame of FIG. 2 with metallic reinforcing elements inserted therein, in a view from above (top view).

FIG. 1 shows a self-inking stamp 1, in particular with overstroke inking and with a turning mechanism W, which will not be discussed in detail below, in a resting position, standing on a substrate (not shown). The self-inking stamp 1 comprises a lower part 2 below an upper part O, in which a stamp unit 4 coupled to an actuating part 3 that is displaceable relative to the lower part 2 is mounted. In the example according to FIG. 1, the actuating part 3 is formed with a handle 3a and forms an upper end of the self-inking stamp 1. In the example shown, the stamp unit 4 comprises a type unit 4a, but could also comprise a stamp plate in an embodiment that is not shown. The lower part 2 comprises two side parts 5, cf. also FIG. 3, which are connected to one another at a bottom end 6 of the lower part 2 by at least one crossbar 8 having a metallic reinforcing element 7. In the example shown, the side parts 5 are designed to guide the stamp unit 4 during a stamping process. In order to be able to manufacture the self-inking stamp 1, in particular the crossbar 8, with the simplest possible steps and in a material-saving manner, the reinforcing element 7 is formed separately from the side parts 5, see FIG. 2, is accommodated in a receptacle 9 of the crossbar 8, and is connected to the side parts 5 via the receptacle 9.

In FIGS. 1 to 7 shown by way of example, two crossbars 8 are provided. The side parts 5 are thus preferably connected to one another at a bottom end 6 of the lower part 2 by two crossbars 8, each comprising a metallic reinforcing element 7. As a result, an opening 10 is formed between the side parts 5 and the crossbars s 8, which allows a stamp print relief 11, i.e. a stamp plate or the illustrated type unit 4a of the stamp unit 4, to pass through in order to produce a stamp imprint on a surface to be printed underneath the self-inking stamp 1. Also in the illustrated case of two crossbars 8, the reinforcing elements 7 are formed separately from the side parts 5, are received in receptacles 9 of the crossbars 8, and are connected to the side parts 5 via the receptacles 9.

In the example according to FIG. 2, it can be seen particularly clearly that the reinforcing element 7 can be a rod 7a, in particular with a round, particularly preferably circular cross-section, i.e. can be a cylindrical rod 7a. The rod 7a may be made of stainless steel. The longitudinal direction of the reinforcing element 7 is illustrated by the arrow L in FIG. 2. The length of the reinforcing element 7 measured in the longitudinal direction I may be greater than, equal to, or less than the distance A between the side parts 5. Even if the length is less than the distance A, the reinforcing element 7 can absorb part of a bending force acting on the crossbar 8.

FIGS. 1, 1A and 2 show that the receptacle 9 comprises an outer shell 12 consisting of at least two crossbar parts 13, exactly two of which are connected to one another in the figures shown. The crossbar parts 13 are preferably formed from plastic. As can be seen, for example, from the enlarged side view of a crossbar 8 in FIG. 1A, each crossbar part 13 preferably comprises an outer surface 14 and an inner surface 15 opposite the outer surface 14 and recessed in the direction of the outer surface 14, the recessed inner surfaces 15 forming the receptacle 9 as a receiving channel 9a when the crossbar parts 13 are connected to one another. It can also be seen in FIGS. 1, 2 and 3 that the reinforcing element 7 can be substantially completely covered by the crossbar parts 13.

The receptacle 9, in particular the receiving channel 9a, can be round in cross-section, preferably circular, cf. e.g. FIG. 1A. This is particularly advantageous if the reinforcing element 7 accommodated in the receptacle 9 also comprises a round, particularly preferably circular, cross-section. This cross-section facilitates the assembly of the reinforcing element 7 because it is not necessary to pay attention to an orientation about the longitudinal axis.

In the exemplary FIGS. 1, 1A and 2, it can also be seen that the crossbar parts 13 of each crossbar 8 can be an upper crossbar part 13a and a lower crossbar part 13b, wherein the lower crossbar parts 13b can additionally extend under the side parts 5 and can jointly form a closed frame 16. The frame 16 may have upwardly projecting, i.e. in the direction of the actuating part 3, for example tongue-shaped insertable elements 17, which can be brought into engagement with the side parts 5 in order to position the frame 16 with respect to the side parts 5. In addition, the frame 16 can have latching elements 18, which can be brought into engagement with complementary latching elements (not shown) in the side parts 5 in order to reliably hold the frame 16 on the side parts 5. The side parts 5 can thus be placed on the frame 16. The frame 16 can also have stamp bases 20 on its bottom side 19 facing a substrate to be printed.

As can be seen from FIG. 3, at least one side part 5, in particular both side parts 5, can have a recess 21 that continues each receptacle 9, in particular each receiving channel 9a, in which the reinforcing element 7 is received, in particular mounted. In the example shown in FIG. 3, the reinforcing element 7 has not yet been received in the receptacle 9. In addition, only the upper crossbar part 13a is shown in FIG. 3, and therefore the receptacle 9, in particular the receiving channel 9a, is not completely shown. The recess 21 may be round in cross-section, preferably having the shape of a circular segment.

In FIG. 4, the lower part 2, which comprises a part of the receptacle 9 or of the receiving channel 9a, is shown in a side view. This part of the receptacle 9 or of the receiving channel 9a is formed by the upper crossbar part 13a. The receptacle 9 is formed or closed by connecting the upper crossbar part 13a to the lower crossbar part 13b shown, for example, in FIG. 5.

FIGS. 2, 3 and 5 also show that the crossbar parts 13 forming the receptacle 9, in particular the receiving channel 9a, are detachably connected to one another, in particular are connected to one another by a latching connection 22. The latching connection 22 can, for example, comprise a spring-mounted hook element 23 on one of the crossbar parts 13, which engages in a complementary hook receptacle 24 on the other crossbar part 13.

To reinforce the crossbar 8 or the two crossbars 8, the side parts 5 are provided with at least a part of the receptacle 9, and the reinforcing element 7 is then mounted in the receptacle 9. FIG. 5 shows the frame 16 in a perspective view from above, wherein, in contrast to the illustration in FIG. 2, the reinforcing elements 7 have already been inserted into the frame 16, in particular into the lower crossbar parts 13b. Likewise, the reinforcing elements 7 could first be inserted into the upper crossbar parts 13a. The crossbar parts 13 with the reinforcing elements 7 inserted therein are then connected, for example latched, to the other, still empty crossbar parts 13 of the crossbar 8 in order to close the receptacles 9 with the reinforcing elements 7 inserted therein and to form the finished crossbars 8.

Although the self-inking stamp 1 is illustrated in FIGS. 1 to 7 with two crossbars 8, the self-inking stamp 1 may also have only a single crossbar 8. In addition, in contrast to the illustrations in FIGS. 1 to 7, the receptacle 9 of each crossbar 8 may not be formed as a continuous, elongated receiving channel 9a, but rather by two pipe sections, which are fastened to the side parts 5 and substantially correspond to a receiving channel from which a section between its ends has been removed. In this case, the reinforcing element 7 is only partially covered by the receptacle 9.

1. A self-inking stamp (1) comprising a lower part (2) in which a stamp unit (4) coupled to an actuating part (3, 3a) that is displaceable relative to the lower part (2) is mounted, the lower part (2) comprising two side parts (5) which are connected to one another at a bottom end (6) of the lower part (2) by at least one crossbar (8) comprising a metallic reinforcing element (7), wherein the reinforcing element (7) is formed separately from the side parts (5), is accommodated in a receptacle (9) of the crossbar (8), and is connected to the side parts (5) via the receptacle (9).

2. The self-inking stamp (1) according to claim 1, wherein the side parts (5) are connected to one another at a bottom end (6) of the lower part (2) by two crossbars (8), each comprising a metallic reinforcing element (7), as a result of which an opening (10) for the passage of a stamp print relief (11) of the stamp unit (4) is formed between the side parts (5) and the crossbars (8), the reinforcing elements (7) being formed separately from the side parts (5), being accommodated in receptacles (9) of the crossbars (8), and being connected to the side parts (5) via the receptacles (9).

3. The self-inking stamp (1) according to claim 1, wherein the receptacle (9) is formed from plastic.

4. The self-inking stamp (1) according to claim 3, wherein the receptacle (9) comprises an outer shell (12) made of at least two interconnected crossbar parts (13) made of plastic.

5. The self-inking stamp (1) according to claim 4, wherein each crossbar part (13) comprises an outer surface (14) and an inner surface (15) opposite the outer surface (14) and recessed in the direction of the outer surface (14), wherein the recessed inner surfaces (15) form the receptacle (9) as a receiving channel (9a) in a connected state of the crossbar parts (13).

6. The self-inking stamp (1) according to claim 4, wherein the crossbar parts (13) of each crossbar (8) are an upper crossbar part (13a) and a lower crossbar part (13b), and the lower crossbar parts (13b) additionally extend under the side parts (5) and jointly form a closed frame (16).

7. The self-inking stamp (1) according to claim 1, wherein both side parts (5) have a recess (21) continuing each receptacle (9), wherein the reinforcing element (7) is received in the recess.

8. The self-inking stamp (1) according to claim 7, wherein the recesses (21) each continue the receiving channel (9a).

9. The self-inking stamp (1) according to claim 7, wherein the reinforcing element (7) is mounted in the recesses (21).

10. The self-inking stamp (1) according to claim 1, wherein the reinforcing element (7) is a rod (7a).

11. The self-inking stamp (1) according to claim 10, wherein the reinforcing element (7) comprises a round cross-section.

12. The self-inking stamp (1) according to claim 11, wherein the cross-section is circular.

13. The self-inking stamp (1) according to clam 10, wherein the rod (7a) is made of stainless steel.

14. The self-inking stamp (1) according to claim 1, wherein the receptacle (9) is round in cross-section.

15. The self-inking stamp (1) according to claim 14, wherein at least one of the receiving channel (9a) and the recess (21) is round in cross-section.

16. The self-inking stamp (1) according to claim 14, wherein at least one of the receptacle (9), the receiving channel (9a), and the recess (21) is circular in cross-section.

17. The self-inking stamp (1) according to claim 4, wherein the reinforcing element (7) is substantially completely covered by the crossbar parts (13).

18. The self-inking stamp (1) according to claim 4, wherein the crossbar parts (13) that are forming the receptacle (9) are detachably connected to one another.

19. The self-inking stamp (1) according to claim 4, wherein the crossbar parts (13) that are forming the receiving channel (9a) are detachably connected to one another.

20. The self-inking stamp (1) according to claim 18, wherein the crossbar parts (13) are connected to one another by a latching connection (22).

21. A method for reinforcing a crossbar (8) of a self-inking stamp (1) formed according to claim 1, wherein the side parts (5) are provided with at least a part of a receptacle (9) and the reinforcing element (7) is then mounted in the receptacle (9).

22. A method for reinforcing a transverse web (8) of a self-inking stamp (1) formed according to claim 4, wherein the reinforcing element (7) is inserted into a crossbar part (13) of the crossbar (8) and the crossbar part (13) with the reinforcing element (7) inserted therein is connected to the other crossbar part (13) of the crossbar (8).
